(19) United States
(12) Patent Application Publication
(10) Pub. No.: US 2011/0050956 A1
(43) Pub. Date: Mar. 3, 2011

(54) IMAGING APPARATUS, METHOD THEREFOR, AND STORAGE MEDIUM

(75) Inventor: Hiromi Bessho, Tokyo (JP)

(73) Assignee: CANON KABUSHIKI KAISHA, Tokyo (JP)

(21) Appl. No.: 12/872,818

(22) Filed: Aug. 31, 2010

(30) Foreign Application Priority Data
Sep. 2, 2009 (JP) 2009-202963

(51) Int. Cl. H04N 5/76

(52) U.S. Cl. 348/231.3; 348/E05.024

(57) ABSTRACT

An imaging apparatus reads a template, in which storage area information, which indicates a plurality of frames for storing an image of an object captured by an imaging device, is associated with shooting instruction information for instructing shooting of an image to be stored in each of the plurality of frames, and if an image to be stored in one of the plurality of frames is to be captured, outputs the shooting instruction information associated with one storage area in the read template, to an output device. With the above-described configuration, the imaging apparatus facilitates shooting an image by a photographer.

### BACKGROUND OF THE INVENTION

1. Field of the Invention

The present invention relates to an imaging apparatus and a method configured to facilitate a photographer shooting an image.

2. Description of the Related Art

A conventional storage device for a digital camera, such as a memory card or a hard disk, has an increasingly large capacity while costs thereof have become lower and lower. Under these circumstances, an increasing number of images has been captured by a photographer.

Japanese Patent Application Laid-Open No. 2007-20104 discusses a method for reducing an unbalance in the numbers of captured images of a plurality of objects. In this conventional method, faces of a plurality of objects to be captured are previously registered and face recognition is executed during shooting.

However, in producing an album of images of a specific category or theme, such as “wedding ceremony”, “kids' athletic meeting”, or “travel”, it is necessary to first classify captured images in chronological order or into a plurality of scenes and select desired images from among the images included in each temporal unit or each scene. Accordingly, it becomes necessary for the photographer to execute complicated operations after shooting.

### SUMMARY OF THE INVENTION

The present invention is directed to an imaging apparatus and a method for facilitating image-capturing of an image by a photographer.

According to an aspect of the present invention, an imaging apparatus includes a reading unit configured to read a template, in which storage area information, which indicates a plurality of storage areas for storing an image of an object captured by an imaging device, is associated with shooting instruction information for instructing shooting of an image to be stored in each of the plurality of storage areas and an output unit configured, if an image to be stored in one of the plurality of storage areas is to be captured, to output the shooting instruction information associated with the one storage area in the template read by the reading unit, to an output device.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to describe the principles of the invention.

FIG. 1A is a block diagram illustrating an exemplary hardware configuration of an information processing apparatus. FIG. 1B is a block diagram illustrating an exemplary hardware configuration of an imaging apparatus.

FIG. 2 is a flow chart illustrating an exemplary flow of processing according to a first exemplary embodiment of the present invention.

FIG. 3A illustrates an example of a template. FIG. 3B illustrates an example of a shooting instruction table.

FIG. 4 illustrates an example of an inner format of a template.

FIG. 5 illustrates an example of an inner format of an information-added template.

FIG. 6 illustrates an example of an imaging apparatus viewed from the back side thereof.

FIGS. 7A and 7B illustrate an example of information displayed on a liquid crystal display (LCD) that displays an image according to the first exemplary embodiment of the present invention.

FIG. 8 is a flow chart illustrating an exemplary flow of processing executed by an imaging apparatus according to the first exemplary embodiment of the present invention.

FIG. 9A through 9C illustrate an example of a method for comparing a frame and a captured image.

FIG. 10 is a flow chart illustrating an exemplary flow of processing according to a second exemplary embodiment of the present invention.

FIGS. 11A and 11B illustrate an example of information displayed on an LCD that displays an image according to the second exemplary embodiment of the present invention.

FIG. 12 is a flow chart illustrating an exemplary flow of processing executed by an imaging apparatus according to the second exemplary embodiment of the present invention.

FIG. 13 is a flow chart illustrating an exemplary flow of processing according to a third exemplary embodiment of the present invention.

FIG. 14 illustrates an example of information displayed on an LCD that displays an image according to the third exemplary embodiment of the present invention.

FIGS. 15A through 15C illustrate an example of information displayed on an LCD that displays an image according to the third exemplary embodiment of the present invention.

### DETAILED DESCRIPTION OF THE EMBODIMENTS

Various exemplary embodiments, features, and aspects of the invention will be described in detail below with reference to the drawings.

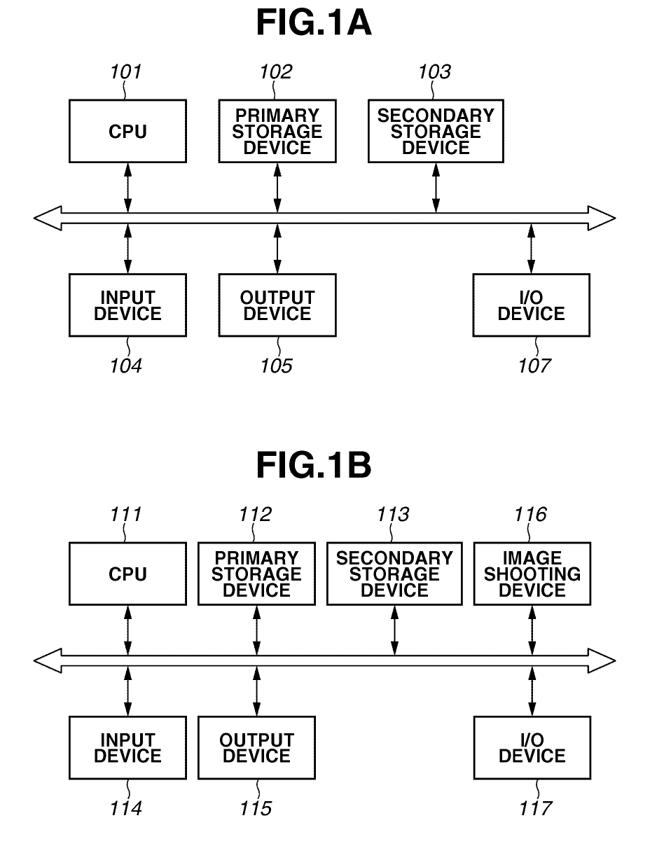

A first exemplary embodiment of the present invention will now be described below. FIG. 1A is a block diagram illustrating an exemplary hardware configuration of an information processing apparatus according to the present exemplary embodiment. Referring to FIG. 1A, the information processing apparatus includes a central processing unit (CPU) 101, a primary storage device 102, a secondary storage device 103, an input device 104, an output device 105, and an input/output (I/O) device 107. The information processing apparatus according to the present exemplary embodiment is implemented by a personal computer (PC).

The CPU 101 controls an operation of the entire information processing apparatus. In addition, the CPU 101 executes a program stored on the primary storage device 102. The primary storage device 102 is a random access memory (RAM), for example. The primary storage device 102 temporarily stores a program loaded by the CPU 101 from the secondary storage device 103.

The secondary storage device 103 is a hard disk, for example. The capacity of the primary storage device 102 is smaller than the capacity of the secondary storage device 103. The secondary storage device 103 stores a program and data that cannot be fully or partially stored on the primary storage device 102. Furthermore, data that needs to be stored for a relatively long time is also stored on the secondary storage device 103.

In the present exemplary embodiment, the secondary storage device 103 stores a program that implements processing executed by the information processing apparatus. In executing the program, the program is loaded on the primary storage device 102 and executed by the CPU 101. More specifically, a function of the information processing apparatus and processing executed by the information processing apparatus, which will be described in detail below with reference to flow charts below, are implemented by the CPU 101 by executing the processing according to the program stored on the secondary storage device 103. Each of the primary storage device 102 and the secondary storage device 103 is an example of a storage device that stores various data according to the present exemplary embodiment.

The input device 104 inputs various instructions. The input device 104, which includes a mouse, a keyboard, a touch panel device, and a button, is an example of an instruction input unit according to the present exemplary embodiment. In addition, the input device 104 is used to transmit an interruption signal to the program.

The output device 105 outputs various information. The output device 105 is, for example, an LCD panel, an external monitor, and a printer.

The I/O device 107 is an interface unit, which includes an external memory I/O device, such as a memory card, an I/O unit, such as a universal serial bus (USB) cable, and a wireless signal transmission and reception unit.

The I/O device 107 is an example of a connection unit configured to connect various apparatuses. More specifically, the I/O device 107 implements a wired or wireless communication with an I/O device 117, which will be described below.

FIG. 1B is a block diagram illustrating an exemplary hardware configuration of an imaging apparatus according to the present exemplary embodiment. The imaging apparatus according to the present exemplary embodiment is implemented by a digital camera.

The imaging apparatus includes a CPU 111, a primary storage device 112, a secondary storage device 113, an input device 114, an output device 115, an imaging device 116, and an I/O device 117. The devices included in the imaging apparatus having the same name have a function similar to that of the devices included in the information processing apparatus. Accordingly, the detailed description thereof will not be repeated below.

In the present exemplary embodiment, the secondary storage device 113 stores a program that implements processing executed by the imaging apparatus. In executing the program, the program is loaded on the primary storage device 112 and executed by the CPU 111. More specifically, a function of the imaging apparatus and processing executed by the imaging apparatus, which will be described in detail below with reference to flow charts below, are implemented by the CPU 111 by executing the processing according to the program stored on the secondary storage device 113.

The imaging device 116 includes an imaging element, an analog-to-digital (A/D) converter, and a storage unit. The imaging element receives light reflected on an object, which is incident to the imaging device 116 via an image lens, converts the received light into an image signal, and outputs the converted signal. The A/D converter converts the image signal output by the imaging element into image data. The storage unit stores the image data output by the A/D converter. An image captured by the imaging device 116 (i.e., a captured image) is directly or indirectly stored on the primary storage device 112 or the secondary storage device 113.

However, the present exemplary embodiment is not limited to the above-described configuration. More specifically, it is also useful if the information processing apparatus includes an imaging device similar to the above-described imaging device 116.

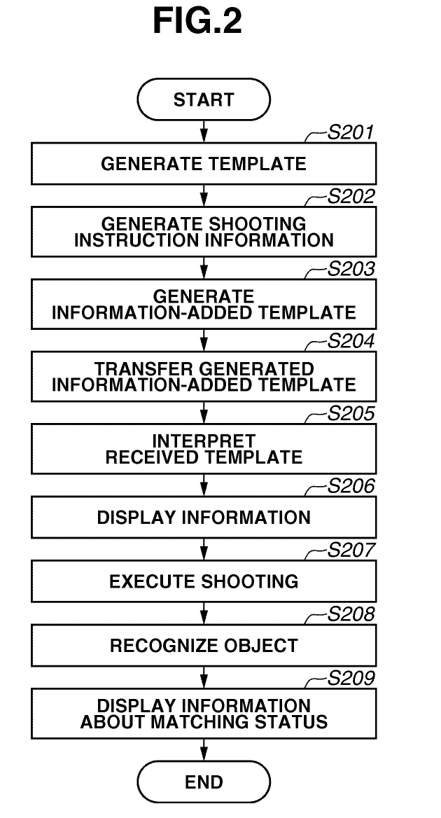

FIG. 2 is a flow chart illustrating an exemplary flow of processing according to the present exemplary embodiment.

Referring to FIG. 2, in step S201, the CPU 101 generates a template. In the present exemplary embodiment, a “template” refers to data generated by using general-purpose graphics software, which is installed on the secondary storage device 103 of the information processing apparatus and activated by a user of the information processing apparatus.

More specifically, the CPU 101 generates a template according to a user instruction. In other words, in the present exemplary embodiment, a “template” refers to data stored on the secondary storage device 103 in a general-purpose format, such as extended Markup Language (XML) or scalable vector graphics (SVG).

In the present exemplary embodiment, data for one carrier or data for one book including a plurality of carriers is referred to as a “template”. In the present exemplary embodiment, the user uses the general-purpose graphics software to determine the size of one carrier. Furthermore, the user sets a layout of the carrier for a content place folder (hereinafter simply referred to as a “frame”), which stores a picture (i.e., an object image), a text, and a clip art, by using the input device 104.

A template having a frame includes at least one image. For the size of one carrier, an A4 standard size or a 210×210 [mm] square size can be used. In addition, the user can execute various operations while verifying a setting and information displayed on the output device 105.

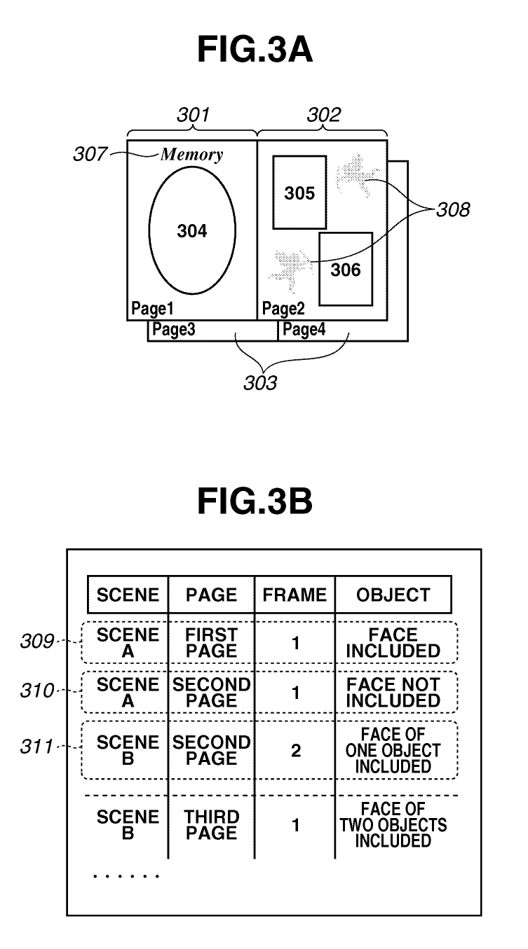

Now, an exemplary configuration of the template will be described in detail below with reference to FIG. 3A. Referring to FIG. 3A, a carrier 301, which indicates one full carrier, includes a frame 304. In the example illustrated in FIG. 3A, the frame 304 has a vertically oval shape. In the present exemplary embodiment, it is supposed that the carrier 301 is a template for a first page. An image is stored in various frame areas. It is useful if the image stored in the frame area is previously subjected to various image processing, such as trimming.

A carrier 302, which indicates one full carrier as the carrier 301, is a template for a second page. The carrier 302 includes frames 305 and 306, which stores an image, respectively.

A specific area 307, which is included in the carrier 301, stores a text. A specific area 308, which is included in the carrier 302, stores a clip art. The text and the clip art are used to decorate an album. As described above, a template includes one or more frame areas and specific areas.

In addition, a template 303 is a template for third and fourth pages. In the present exemplary embodiment, it is useful to use an “album template”, which is a template for a book (i.e., an album) including a plurality of templates for respective pages. More specifically, a template may include a plurality of pages or one page.

In the present exemplary embodiment, a template stores images of a consistent theme, such as “wedding ceremony”, “kids' athletic meeting”, or “travel”. To more specifically describe images of the theme “wedding ceremony”, the images are likely to be classified into and selected from those included in scenes, such as “before the ceremony”, “ceremony”, and “wedding reception” in this chronological order. Furthermore, the images are arranged in frames starting from a first page.

Accordingly, the present exemplary embodiment uses shooting instruction information, which is information for instructing to which frame included in a template which object image is stored. In the present exemplary embodiment, it is supposed that scenes progress according to order of pages. In addition, in the present exemplary embodiment, it is supposed that one or more frames correspond to one scene.

However, a scene break may not always correspond to a page break. Furthermore, one scene may correspond to a plurality of pages. On the other hand, one scene may end in the middle of a page.

Returning to the flow chart of FIG. 2, in step S202, the CPU 101 generates shooting instruction information.

Now, the shooting instruction information will be described in detail below with reference to FIG. 3B. The shooting instruction information includes a content included in a shooting instruction table illustrated in FIG. 3B. More specifically, the shooting instruction table illustrated in FIG. 3B is generated by the user by using the input device 104 and general-purpose spreadsheet software, which is installed on the information processing apparatus on the secondary storage device 103 and activated by the user to generate the table.

Data held in the shooting instruction table (shooting instruction information table data) is stored on the primary storage device 102 or the secondary storage device 103. The shooting instruction table illustrated in FIG. 3B corresponds to the template illustrated in FIG. 3A. More specifically, the shooting instruction table stores information about which scene belongs to which frame for what page. In addition, the shooting instruction table illustrated in FIG. 3B stores information about which object image is to be stored in each frame (i.e., information about whose image is to be stored in which frame).

More specifically, information included in a row 309, which is illustrated in FIG. 3B by using a dotted rectangle, is information for instructing (notifying) a photographer that an image of one or more persons' faces is included in a first frame of a first page, which corresponds to a scene A.

Furthermore, information included in a row 310, which is illustrated in FIG. 3B by using a dotted rectangle similar to the row 309, is information for instructing (notifying) the photographer that an image including no person's face is included in a first frame of a second page, which corresponds to the scene A.

Moreover, information included in a row 311, which is illustrated in FIG. 3B by using a dotted rectangle, is information for instructing (notifying) the photographer that the scene has shifted from the scene A to a scene B and that an image of one person's face only is included in a second frame of the second page.

In the example illustrated in FIG. 3B, a content of the object, such as “face included”, “face not included”, “face of one object included”, and “face of two objects included”, is illustrated. However, it is also useful if a proper noun, i.e., a personal name, such as “Ms. A”, “Mr. B”, “Mr. C”, or “Ms. A and Mr. B”, is used as the content of the object. Alternatively, it is also useful if a common noun, such as “man” or “woman”, is used as the content of the object. In addition, in the example illustrated in FIG. 3B, it is supposed that the object whose information is stored in the shooting instruction table is a person. However, it is also useful if the object is an object other than a person, such as scenery, a building or other architecture, a flower, or a material.

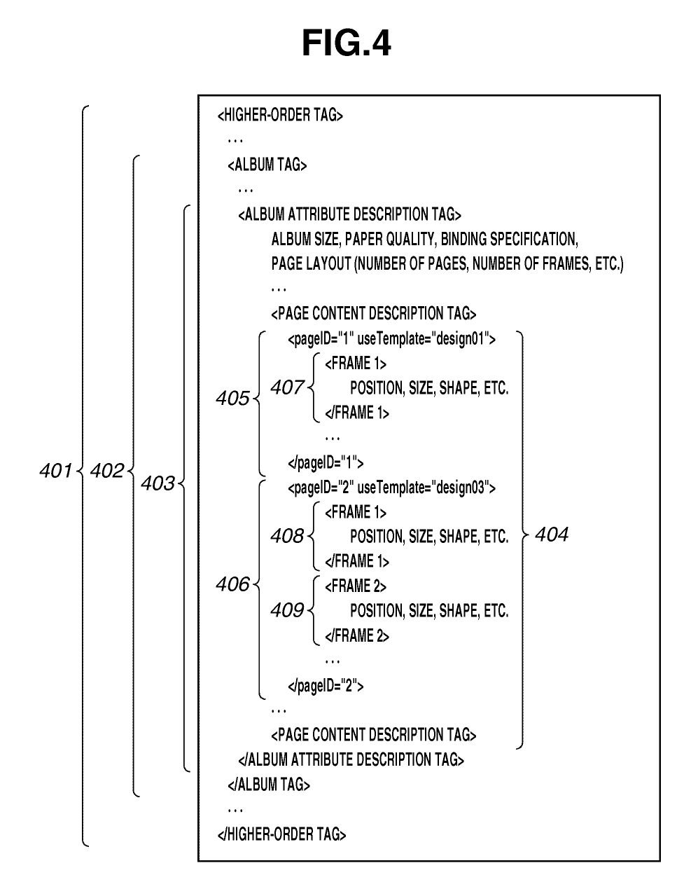

Now, an exemplary configuration of a template will be described in detail below with reference to FIG. 4. FIG. 4 illustrates an example of an inner format of a template (i.e., template data). In the present exemplary embodiment, template data is described with various tags.

Referring to FIG. 4, the template data includes an upper tag 401, such as an extended Markup Language (XML) tag. In addition, the template data includes tags 402 through 409, which is characteristic to the present exemplary embodiment. More specifically, the tag 402 is an album tag, which corresponds to one album. The album attribute description tag 403 describes an attribute of an album, such as the size of the album, quality of paper sheet used in the album, a binding specification, and a page layout including the number of pages and the number of frames.

The page content description tag 404 describes the content of a page included in an album book. As its content, the page content description tag 404 includes first and second page tags 405 and 406, each of which describing the content of each page. More specifically, the first page tag 405 includes a frame tag 407, which corresponds to a first frame of the first page. In addition, the second page tag 406 includes a frame tag 408, which corresponds to a first frame of the second page, and a frame tag 409, which corresponds to a second frame of the second page. The content of the frame tag includes information about a frame, such as its position, size, and shape.

Returning to the flow chart of FIG. 2, in step S203, the CPU 101 generates an information-added template.

In the present exemplary embodiment, an “information-added template” refers to a template whose template data (FIG. 4) additionally includes information about an object, which describes the content of the object included in the shooting instruction table (i.e., information such as “face included”, or the like). In other words, an information-added template is generated by combining template data stored on the primary storage device 102 or the secondary storage device 103 with shooting instruction table data.

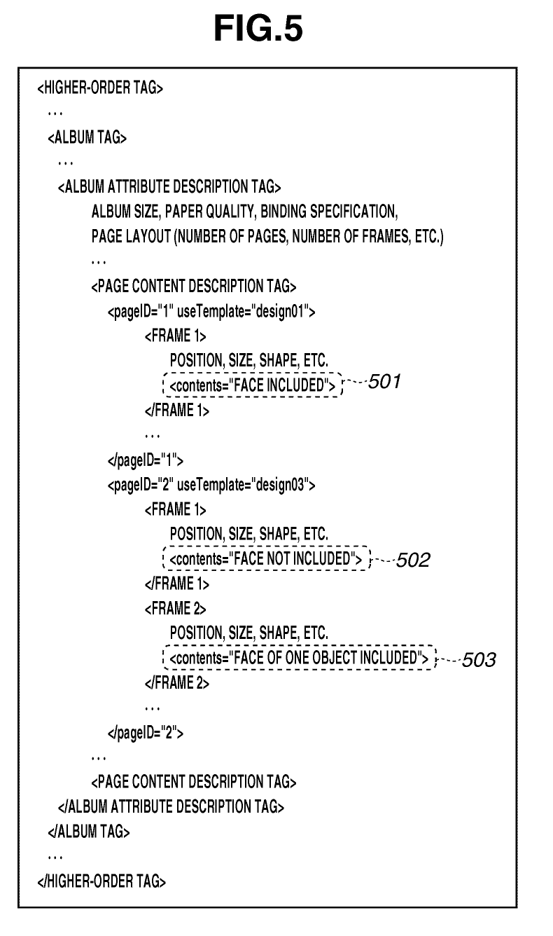

Now, an exemplary configuration of an information-added template will be described in detail below with reference to FIG. 5. FIG. 5 illustrates an example of an inner format of an information-added template, which is generated by combining template data with shooting instruction table data (i.e., information-added template data).

Referring to FIG. 5, a tag 501 describes that an image including “one or more faces” is stored in the first frame of the first page. Furthermore, a tag 502 describes that an image including “no face” is stored in the first frame of the second page. Moreover, a tag 503 describes that an image including “one face only” is stored in the second frame of the second page.

In the present exemplary embodiment, the CPU 101 sequentially executes the processing in steps S201 through S203. However, the order of executing the processing in steps S201 and S202 may be reversed. Furthermore, it is also useful if the user opens template data by using a general-purpose editor program and directly adds shooting instruction information to the template data to generate an information-added template.

Returning to the flow chart of FIG. 2, in step S204, the CPU 101 stores the information-added template on the memory card via the I/O device 107. Furthermore, the CPU 101 transfers the information-added template to the imaging apparatus.

In step S205, the CPU 111 of the imaging apparatus interprets the content of the information-added template transferred thereto in step S204. More specifically, by executing the interpretation processing, it becomes possible for the CPU 111 to appropriately refer to images classified according to the number of pages, a scene, and an object based on a frame number.

More specifically, at first, the CPU 111 loads an information-added template by using application software operating within the imaging apparatus. Then, the CPU 111 determines the order of a plurality of frames arranged and included in template data according to an order of frame tags described in the template data and assigns a serial number to each frame.

After that, the CPU 111 associates the frames included in the template with the order of the frames. Then, the CPU 111 further associates the frames, which has been associated with the frame order, with attribute information including the shape of the template, a background color thereof, and positional information about the position of the frame.

Subsequently, the CPU 111 previously inputs, to an array of the primary storage device 112 included in the imaging apparatus, information about in what page of the template each frame is laid out, to which scene each frame belongs, and what object is requested.

By executing the above-described processing, it becomes possible for the CPU 111 to refer the image classified according to the number of pages, a scene, and an object based on the frame number.

In other words, the CPU 111 generates a table (i.e., Table 1 described below) based on the information-added template. Table 1 simply describes a result of the interpretation of the information-added template (see FIG. 5) by the CPU 111, which describes which frame belongs to which page of which scene, and what image of the object is requested.

More specifically, the CPU 111 determines which frame is the target frame based on a Frame variable. Furthermore, the CPU 111 determines to which scene the frame belongs based on a Scene variable. In addition, the CPU 111 determines to which page the scene belongs based on a Page variable. Moreover, what image of the object is requested is determined based on a Content variable.

In the present exemplary embodiment, a Flag variable is a variable newly added by the imaging apparatus, which indicates whether an image has been already captured. A value “0” is set to a Flag variable as its initial value. In other words, if an image has been already captured, a value “1” is set as the value of the Flag variable. Accordingly, Table 1 functions as a table of progress of shooting, which indicates the status of progress of shooting according to the present exemplary embodiment.

TABLE 1

| Frame | Scene | Page | Flag | Content |
|---|---|---|---|---|
| 0 | 0 | 0 | 0 | Face Included |
| 1 | 0 | 1 | 0 | NO Face Included |
| 2 | 1 | 1 | 0 | One Face Included |
| 3 | 1 | 2 | 0 | Two Faces Included |
| 4 | 1 | 2 | 0 | . . . |
| . . . | . . . | . . . | . . . | . . . |

More specifically, the imaging apparatus includes a reading unit configured to read a template including storage area information and shooting instruction information. The storage area information describes a plurality of storage areas that stores an image of an object captured by the imaging device 116. The shooting instruction information is information about shooting associated with each of the plurality of storage areas. The CPU 111, for example, implements the reading unit according to the present exemplary embodiment.

As the storage area information describing a storage area (i.e., a frame), tags 407 through 409, each of which describing a frame, are used in the present exemplary embodiment. More specifically, in the present exemplary embodiment, a “template” is a higher-order concept including an information-added template.

Returning to the flow chart of FIG. 2, in step S206, the CPU 111 displays the content (information) of the information-added template, which has been interpreted instep S205, on the output device 115 or the output devices 105 included in the imaging apparatus, such as an LCD monitor.

Suppose that the operation mode of the imaging apparatus has been set to a shooting mode, that a lens of the imaging apparatus is focused on an object, and that an image of the object has been displayed on the output device 115. In this case, the output device 115 further displays information about what object is to be captured in which frame of which page of which scene (shooting instruction information). It is also useful if the CPU 111 executes control of the output device 115 for displaying a part of or all the contents of the shooting progress status table.

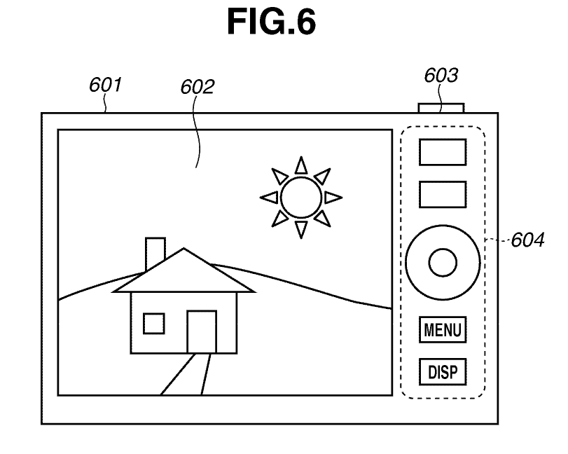

Now, an exemplary primary configuration of the imaging apparatus will be described in detail below with reference to FIG. 6. FIG. 6 illustrates an example of the imaging apparatus viewed from the back side thereof. Referring to FIG. 6, an image display LCD monitor 602, which is an example of the output device 115, is provided on a back side 601 of the imaging apparatus. A button 603, which is an example of the imaging device 116, can be operated to execute an operation of a shutter or zooming.

An interface 604, which is an example of the input device 114, is an interface for executing various other operations. In executing shooting, the photographer confirms the content (information) displayed on a screen of the image display LCD monitor 602, changes various settings by operating the interface 604, and releases the shutter included in the button 603.

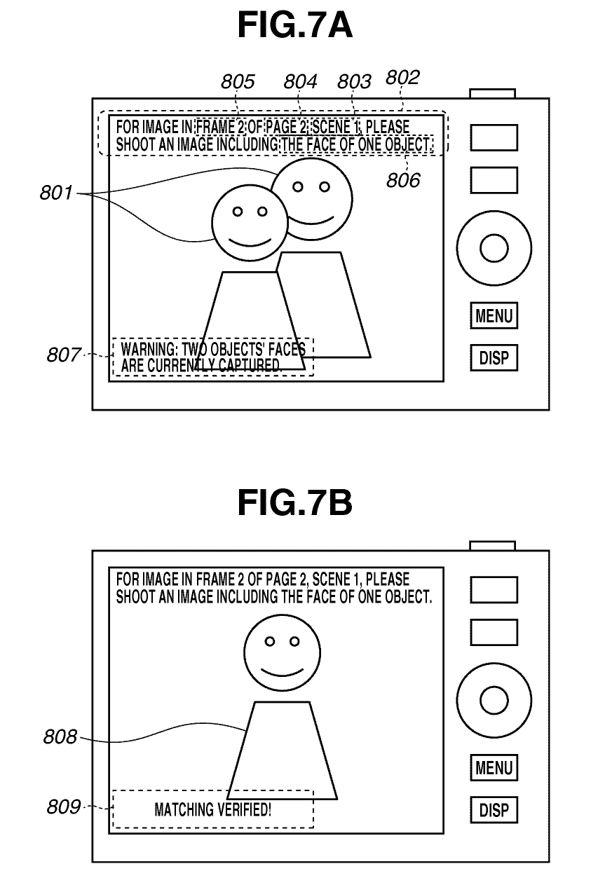

Now, an exemplary configuration of the screen of the image display LCD monitor 602 will be described in detail below with reference to FIGS. 7A and 7B. FIGS. 7A and 7B illustrate an example of information displayed on the image display LCD monitor 602. Referring to FIG. 7A, an object 801 is displayed on the image display LCD monitor 602.

Information 802 is an example of information displayed in step S206 (FIG. 2). In the example illustrated in FIG. 7A, a shooting instruction, which instructs shooting of an object, is displayed on the image display LCD monitor 602. More specifically, the shooting instruction instructs shooting of “one object face” (face of one object (person)) for a “frame 2” (a second frame) of “page 2” of “scene 1”, which portions of the instruction being description portions 806, 805, 804, and 803 in this order.

More specifically, the imaging apparatus includes an output unit configured, in shooting an image to be stored on one of the plurality of storage areas, to output shooting instruction information associated with one storage area according to the read template to the output device 115. As an example of the output unit, the present exemplary embodiment employs the CPU 111.

In the present exemplary embodiment, information subsequent to current information can be displayed without displaying the current information. If the display of current information is skipped, the content about a currently requested object is also skipped.

In addition, in the present exemplary embodiment, it is possible to display a list of shooting instructions. More specifically, the imaging apparatus includes a selection unit (i.e., the CPU 111 for example) configured to allow the photographer to select one piece of shooting instruction information from among a plurality of pieces of shooting instruction information, which can be output by the output device 115.

Returning to the flow chart of FIG. 2, in step S207, the CPU 111 of the imaging apparatus executes control for shooting an image, which is a candidate of an image to be stored in a frame. The captured image is stored on the primary storage device 112 or the secondary storage device 113 of the imaging apparatus.

In step S208, the CPU 111 executes image recognition on an image captured and stored on the primary storage device 112 or the secondary storage device 113 in step S207. By executing the image recognition, the CPU 111 recognizes the content of the captured object image (i.e., what object is taken in the image).

More specifically, if an image illustrated in FIG. 7A is displayed on the image display LCD monitor 602, the CPU 111 recognizes that “two faces” are included in the object image. In other words, the imaging apparatus includes a recognition unit configured to recognize an object based on an image captured by the imaging device 116. The CPU 111 is the recognition unit as an example thereof.

In step S209, the CPU 111 displays, on the image display LCD monitor 602, information about a status of matching between the content of the object recognized in step S208 and the content of the object included in the shooting instruction information for the frame, which has been interpreted in step S202.

More specifically, in the example illustrated in FIG. 7A, the currently requested object is “one face” (the portion 806 of the instruction 802), as determined in step S206 but the object recognized in step S208 is “two faces”. Accordingly, in this case, the CPU 111 determines that the requested object does not match the captured image of the object. In this case, the CPU 111 executes control for displaying a warning message 807.

FIG. 7B illustrates an example of another image captured in step S207. More specifically, on the screen illustrated in FIG. 7B, “one face” 808 is displayed. In other words, the content of the currently requested object is “one face”, which is the same as the description included in the portion 806 of the instruction 802 (FIG. 7A). Accordingly, the CPU 111 determines that the requested object matches the object included in the captured image. In this case, the CPU 111 executes control for displaying a message 809, which indicates that the objects match each other.

More specifically, the imaging apparatus includes an identification unit, which is implemented by the CPU 111 and configured to identify whether the recognized object matches an object described in the shooting instruction information output by the output device 115. In addition, the imaging apparatus includes an identification result output unit, which is implemented by the CPU 111, configured to output a result of the identification to the output device 115.

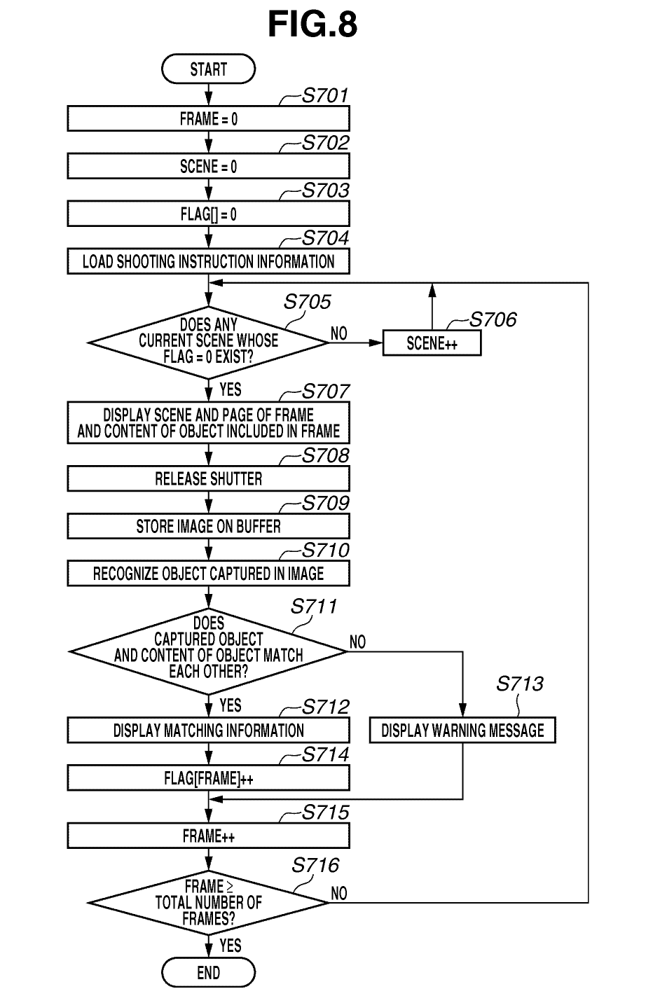

Now, processing in steps S206 through S209 (FIG. 2) of the operation executed by the imaging apparatus, which includes processing starting from step S206 for displaying object information and continued to processing in step S209 for displaying matching status information, will be described in detail below with reference to FIG. 8. The processing illustrated in FIG. 8 will be described in detail below by referring to Flame, Scene, Page, Flag, and Content variables held in the shooting progress status table illustrated in Table 1.

Referring to FIG. 8, in step S701, the CPU 111 of the imaging apparatus assigns a value “0” to a frame counter (“Frame”) (i.e., the CPU 111 resets the frame counter with a value “0”). In step S702, the CPU 111 resets a scene counter (“Scene”) with a value “0”. In step S703, the CPU 111 resets a flag array (“Flag [ ]“), which indicates information about whether a requested image has been captured in each frame, with a value “0”.

In step S704, the CPU 111 loads the shooting instruction information that has been added to the template. In step S705, the CPU 111 determines whether any frame belonging to one scene to which no flag has been set exists (i.e., whether any frame belonging to one scene whose “Flag [Frame]”=0 exists).

If it is determined that the flag has been set to all frames belonging to one scene (NO in step S705), then the processing proceeds to step S706. In step S706, the CPU 111 increments the scene counter. More specifically, if it is determined that the flag has been set to all the frames belonging to one scene (NO in step S705), the CPU 111 can determine that all the images to be stored in the frames of the scene has been already captured. Accordingly, the CPU 111 increments the scene counter.

On the other hand, if it is determined that any frame included in one scene has been extracted to which the flag is not set (YES in step S705), then the processing proceeds to step S707. In step S707, the CPU 111 displays, on the image display LCD monitor 602, the scene and the page to which the frame belongs and the content of the object requested to be stored in the frame according to the frame counter (i.e., the frame number of the frame).

In step S708, the CPU 111 receives an operation executed by the photographer for releasing the shutter. More specifically, instep S708, the photographer executes shooting after confirming the content displayed in step S707. In step S709, the CPU 111 stores the image of the object on the primary storage device 112 (i.e., a buffer).

In step S710, the CPU 111 executes object recognition on the image stored in step S709. In step S711, the CPU 111 determines whether the object recognized in step S710 matches the content of the object requested to be stored in the frame displayed in step S707.

If it is determined that the recognized object matches the content of the object to be stored in the frame (YES instep S711), then the processing proceeds to step S712. In step S712, the CPU 111 executes control for displaying a message indicating the matching status on the image display LCD monitor 602. On the other hand, if it is determined that the recognized object does not match the content of the object to be stored in the frame (NO in step S711), then the processing proceeds to step S713. In step S713, the CPU 111 executes control for displaying the unmatching status on the image display LCD monitor 602.

In step S714, the CPU 111 increments a flag (i.e., “Flag[Frame]”), which stores information about the status of progress of shooting for the frame. In step S715, the CPU 111 increments the frame counter to proceed to the processing for a next frame.

Instep S716, the CPU 111 determines whether shooting has been executed for all the frames existing within the template. If it is determined that the shooting for all the frames has not been completed yet (NO in step S716), then the processing returns to step S705 and continues the processing. On the other hand, if it is determined that shooting has been completed for all the frames included in the template (YES in step S716), then the processing ends.

In the present exemplary embodiment, the CPU 111 resets the scene counter with a value “0” (i.e., “Scene=0”) in step S702, and determines whether any frame included in one scene to which the flag has not been set (i.e., “Flag[Frame]=0”) exists in step S705 as described above. However, the present exemplary embodiment is not limited to this.

More specifically, it is also useful if the CPU 111 resets a page counter with a value “0” instead of resetting the scene counter. In this case, it is also useful if the CPU 111 resets the page counter with a value “0” (i.e., “Page=0”) in step S702, and determines whether any frame included in one scene to which the flag has not been set (i.e., “Flag[Frame]=0”) exists in step S705.

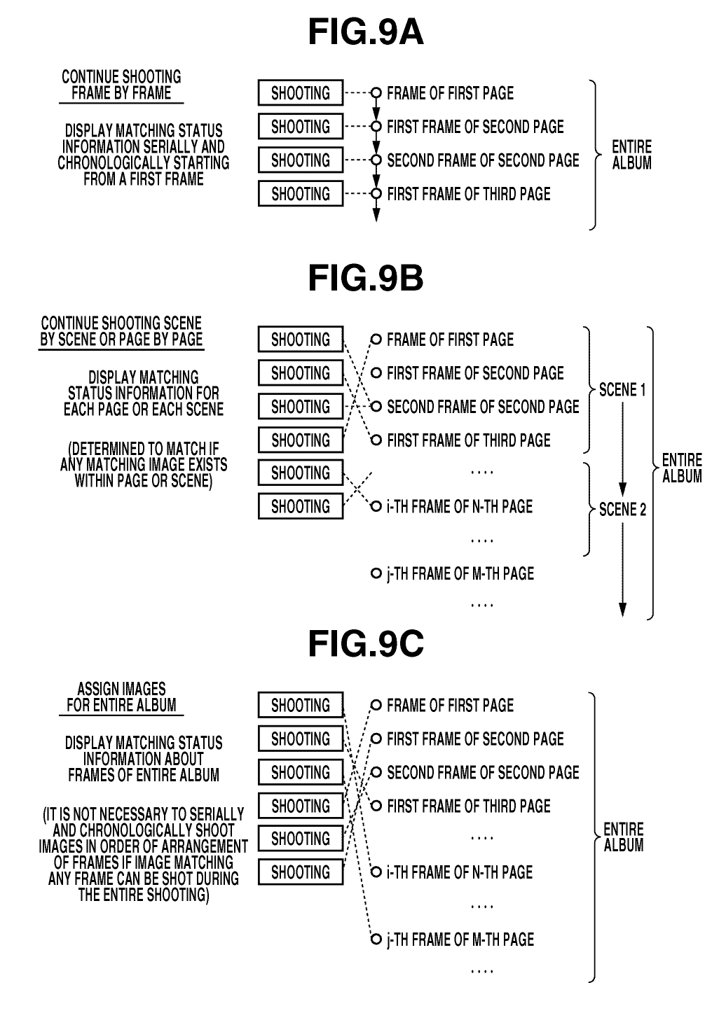

If the counter according to the present exemplary embodiment is processed in the unit of a frame, the shooting progresses in chronological order according to serial numbers assigned to the frames as illustrated in FIG. 9A. On the other hand, if the counter according to the present exemplary embodiment is processed in the unit of a scene or a page as illustrated in the flow chart of FIG. 8, the shooting advances to a next scene or page after shooting for all the frames within a scene or a page has been completed, as illustrated in FIG. 9B.

Furthermore, if it is set that an album includes one scene only, in executing the processing in the flow chart of FIG. 8, the shooting progresses in such a manner that the frame stores images of an object that has been determined positive in the above-described matching, if any, as illustrated in FIG. 9C.

In the present exemplary embodiment, the processing in steps S201 through S203 (FIG. 2) is executed by the information processing apparatus, and the information processing apparatus transmits the information-added template to the imaging apparatus. However, the present exemplary embodiment is not limited to this.

If the information processing apparatus includes a built-in camera (an imaging device) and executes shooting by using the imaging device, it is also useful if the transmission of the template in step S204 (FIG. 2) is omitted, and the information processing apparatus executes the processing in steps S205 through S209.

In addition, it is also useful if the processing in steps S201 through S203 is executed by the imaging apparatus. Furthermore, it is also useful if the template generated by the information processing apparatus is transferred to the imaging apparatus, and the imaging apparatus adds shooting instruction information to the received template. As described above, the apparatus that executes the above-described processing can be appropriately changed.

If it has been permitted (set) by the photographer to shoot a plurality of images for one frame as candidates of images to be stored therein, the following configuration can be employed. More specifically, in this case, it is useful if a list of candidate images, which are candidates of images to be included in one frame, is displayed on the image display LCD monitor 602 and the user is allowed to further narrow down the images to be selected and to assign a priority order to the candidate images.

In addition, if it has been permitted (set) by the photographer to shoot a plurality of images for one frame as candidates of images to be stored therein, the following configuration can also be employed. More specifically, in this case, it is useful if one folder is provided on the primary storage device 112 for one frame, and captured images, which have been previously selected as candidate images to be stored on the frame, are stored in the folder.

Furthermore, the present exemplary embodiment can be applied when capturing moving images as well as capturing still images. Moreover, the present exemplary embodiment can be applied regardless of whether or not the photographer and the user is the same person.

As described above, the information processing apparatus according to the present exemplary embodiment generates combined image data based on template data and image data. In addition, the information processing apparatus previously generates an information-added template. On the other hand, the imaging apparatus according to the present exemplary embodiment interprets the information-added template and displays object information during shooting. With the above-described configuration, the present exemplary embodiment can facilitate shooting an image by the photographer.

By facilitating shooting an image by the photographer, the present exemplary embodiment can prevent the photographer from failing to shoot an image of an object and shooting too many images of objects. Furthermore, by facilitating shooting an image by the photographer, the present exemplary embodiment is capable of saving the photographer (user)'s trouble of having to execute complicated operations for selecting an image after shooting.

To paraphrase this, according to the present exemplary embodiment having the above-described configuration, shooting is executed while facilitating shooting images by the photographer by adding instruction information related to shooting to template data, previously inputting the information to the information processing apparatus, and displaying the shooting instruction information on the output device 105 or 115.

More specifically, in a conventional method, it is difficult to shoot images assuming that the captured images are to be stored with a final layout. On the other hand, according to the present exemplary embodiment having the above-described configuration, the photographer can confirm the images stored with a final layout during shooting.

Therefore, according to the present exemplary embodiment, it is enabled to execute operations for generating an album with a high efficiency in a short processing time.

In the first exemplary embodiment described above, the CPU 111 of the imaging apparatus recognizes an object according to the information, such as “face included” or “face not included”. Alternatively, in the first exemplary embodiment, an object is selected according to a determination by the photographer based on a displayed personal name. Accordingly, it is not difficult for the imaging apparatus to perfectly correctly recognize a person in the captured image.

In a second exemplary embodiment of the present invention, a feature unique to an object is previously registered. Furthermore, during shooting, the feature of an object is recognized and information unique to the object is displayed. Therefore, according to the present exemplary embodiment, the user (photographer) can more easily shoot images appropriate to the user (photographer)'s intension than the first exemplary embodiment.

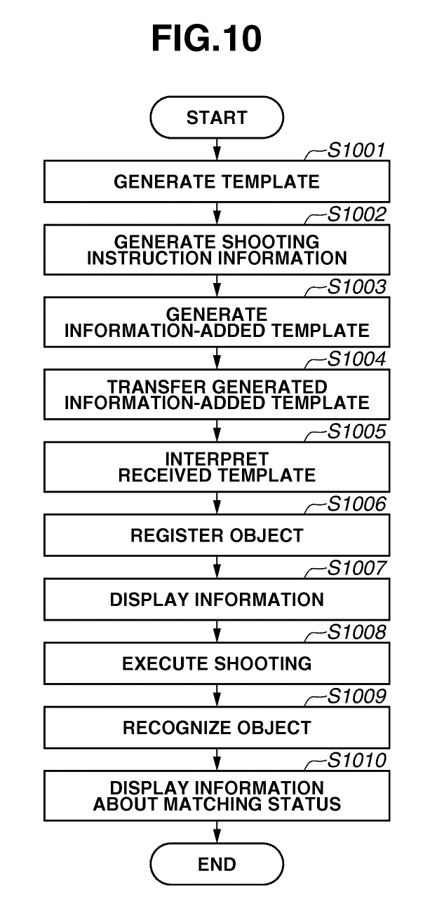

Now, processing executed by the information processing apparatus and the imaging apparatus according to the present exemplary embodiment will be described in detail below with reference to a flow chart of FIG. 10. FIG. 10 is a flow chart illustrating an exemplary representative flow of processing according to the present exemplary embodiment.

In the present exemplary embodiment, description of the hardware configuration or other configuration of the information processing apparatus and the imaging apparatus similar to that of the information processing apparatus and the imaging apparatus according to the first exemplary embodiment will not be repeated.

Referring to FIG. 10, in step S1001, the CPU 101 generates a template similar to the processing in step S201 (FIG. 2). In step S1002, similar to the processing in step S202, the CPU 101 generates shooting instruction information.

In step S1003, the CPU 101 generates an information-added template similarly to the processing instep S203. More specifically, the CPU 101 combines the template generated in step S1001 with the shooting instruction information table generated in step S1002, and generates a template to which a shooting instruction information is added (i.e., an information-added template).

Instep S1004, similar to the processing in step S204, the CPU 101 stores the information-added template on the memory card via the I/O device 107. Furthermore, the CPU 101 transfers the information-added template to the imaging apparatus.

Instep S1005, similar to the processing in step S205, the CPU 111 of the imaging apparatus interprets the content of the template transferred to the imaging apparatus in step S1004.

In other words, in step S1005, the CPU 111 generates a table (i.e., Table 2 described below) based on the information-added template. Table 2 simply describes a result of the interpretation of the information-added template by the CPU 111, which describes which frame belongs to which page of which scene and what image of object is requested.

Accordingly, similar to Table 1 according to the first exemplary embodiment, Table 2 functions as a table of progress of shooting, which indicates the status of progress of shooting according to the present exemplary embodiment.

TABLE 2

| Frame | Scene | Page | Flag | Content |
|---|---|---|---|---|
| 0 | 0 | 0 | 0 | Ms. A |
| 1 | 0 | 1 | 0 | Mr. B |
| 2 | 1 | 1 | 0 | Ms. A and |
| | | | | Mr. B |
| 3 | 1 | 2 | 0 | Mr. C |
| 4 | 1 | 2 | 0 | . . . |
| . . . | . . . | . . . | . . . | . . . |

Processing in step S1006 is characteristic to the present exemplary embodiment. More specifically, in step S1006, the CPU 111 generates a list of objects based on the content of the object interpreted in step S1005, and registers each object. In the present exemplary embodiment, the CPU 111 executes face registration, which is processing for registering the face of a person taken in an image.

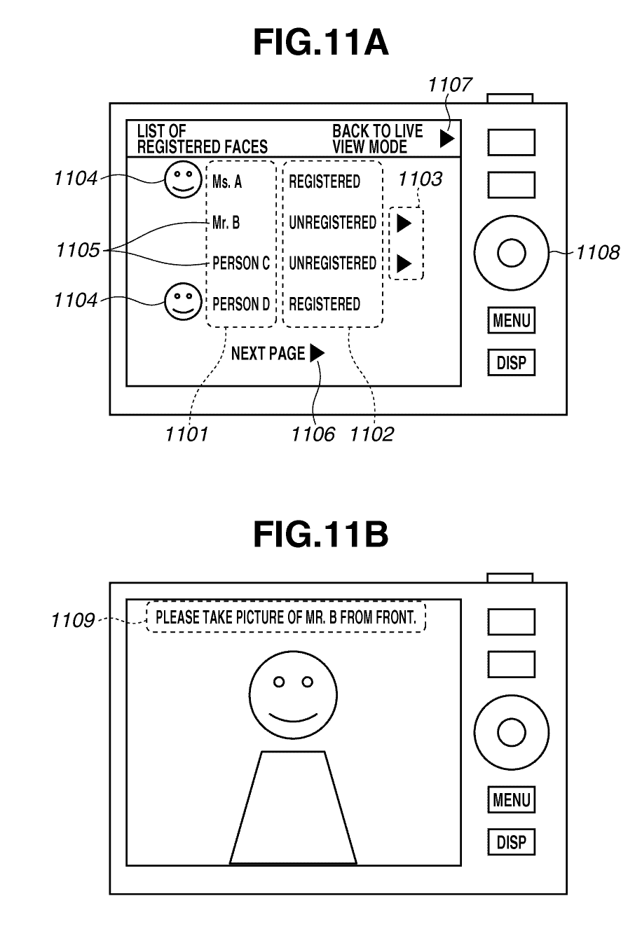

FIG. 11A illustrates an example of a list of registered faces, which is displayed on the image display LCD monitor 602. Referring to FIG. 11A, in a field 1101, the image display LCD monitor 602 displays a list of personal names included in the information-added template, which has been interpreted by the imaging apparatus in step S1005 (FIG. 10). Furthermore, in a field 1102, the image display LCD monitor 602 displays information about each personal name of which face registration has been completed.

In the example illustrated in FIG. 11A, Ms. A and Person D have been already registered as illustrated by registered images 1104. On the other hand, Mr. B and Person C, who are indicated by a numeral 1105, have not been registered yet. The user can register the unregistered persons via a registration screen, which is displayed when the user selects an interface 1103.

In the present exemplary embodiment, an interface for re-registering an already registered person by executing registration of the person again is provided. Thus, the user is allowed to re-register an already registered person. If a very large number of persons have been registered and thus the image display LCD monitor 602 is unable to display all the registered persons in one screen at the same time, then it is also useful if the user is allowed to select an interface 1106 to shift to a next screen.

When the user desires to return to shooting operation, the user can select an interface 1107 to shift the screen to a live view screen. An input device 1108 is a dial type input device. It is also useful if a dial type input device is used as each of the interfaces 1103, 1106, and 1107 as the input device 1108.

In the present exemplary embodiment, when the user selects the interface 1103 to register an unregistered person (for example, Mr. B), the screen of the image display LCD monitor 602 is changed to a screen illustrated in FIG. 11B.

In this case, an instruction message 1009, which prompts the user to shoot an image of the object, is displayed on the screen. After the user has captured the image of the object, the CPU 111 stores a feature amount of the image of the captured face on the secondary storage device 113.

In step S1007, the CPU 111 displays the content of the information-added template, which has been interpreted in step S1006, on the image display LCD monitor 602. More specifically, when the object is currently displayed on the image display LCD monitor 602, the CPU 111 executes control for displaying information for instructing whose image is to be captured for which frame of what page of which scene as well as displaying the image of the object.

In the present exemplary embodiment, “when the object is currently displayed on the image display LCD monitor 602” refers to a timing at which the imaging apparatus is in the shooting mode and the lens has been focusing on the object.

It is also useful if next information is displayed while skipping the display of current information. If the display of the current information is skipped, it is useful if the display of the content of the object whose image has been currently requested to be captured and stored according to the information currently displayed, is skipped. In addition, it is also useful if a list of shooting instructions is displayed.

In step S1008, the imaging apparatus captures an image, which is a candidate of an image to be stored in the frame. The imaging apparatus stores the captured image on the primary storage device 112 or the secondary storage device 113.

Instep S1009, the CPU 111 executes image recognition on the image captured in step S1008 and stored on the primary storage device 112 or the secondary storage device 113. More specifically, in step S1009, the CPU 111 extracts a feature amount of the object (the face of the person (object) in the present exemplary embodiment) by analyzing the image data (in a narrower sense, face data) captured in step S1008. Furthermore, the CPU 111 searches for a person having the most approximate feature amount from among the plurality of feature amounts of the faces registered in step S1006.

It is also useful if the following configuration is employed. More specifically, if the difference between the feature amount of a captured image and the feature amount of a specific registered image falls within a predetermined reference value, the CPU 111 can determine that the same objects are captured in the images.

More specifically, the imaging apparatus includes an extraction unit configured to extract a feature amount of an object from the image of the object captured by the imaging device 116. In the present exemplary embodiment, the CPU 111 is used as an example of the extraction unit.

Instep S1010, the CPU 111 displays information about whether the person recognized in step S1009 matches the person displayed in step S1007 on the image display LCD monitor 602.

More specifically, the CPU 111 compares the extracted feature amount with the feature amount of the image, which has been previously registered in the storage area in association with the output shooting instruction information, of the feature amounts of images to be stored in the storage area described in the storage area information, which is included in the template. In addition, the CPU 111 determines whether the same objects are captured in the images based on a result of the comparison.

Accordingly, the imaging apparatus includes a determination unit configured to determine whether the same objects are captured in the images based on the feature amounts of the images. In the present exemplary embodiment, the determination unit is implemented by the CPU 111, for example. In addition, the imaging apparatus includes a determination result output unit configured to output a result of the determination to the output device 115. In the present exemplary embodiment, the determination result output unit is implemented by the CPU 111, for example.

In the present exemplary embodiment, in step S1006, the CPU 111 registers an object. In addition, in step S1009, the CPU 111 recognizes the object and searches for a unique feature of a person taken in an image. However, the present exemplary embodiment is not limited to this.

More specifically, it is also useful if the CPU 111 registers and recognizes an outer appearance of a person taken in an image, which has a unique feature amount and is other than a face of an object, in addition to or instead of the feature amount of the face.

In addition, it is also useful if it is permitted to shoot a plurality of images as candidates of images to be included in one frame. In this case, it is useful if a list of images that are candidates to be included in one frame is displayed on the image display LCD monitor 602 to allow the user to narrow down and select an image or to set an order to the candidate image.

If it is permitted to shoot a plurality of images as candidates of images to be included in one frame, it is also useful if one folder is provided within the imaging apparatus for one frame, and a captured image, which has been previously selected as the candidate, is selectively stored in the folder.

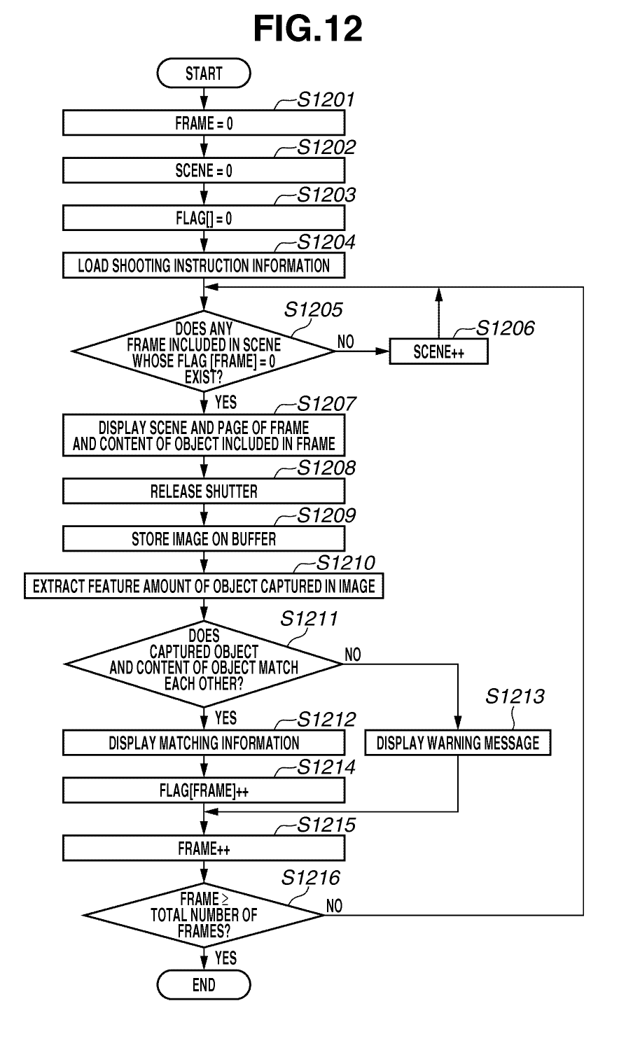

FIG. 12 is a flow chart illustrating an exemplary flow of processing in step S1007 (FIG. 10) for displaying object information through step S1010 (FIG. 10) for displaying matching status information of the processing executed by the imaging apparatus. The flowchart of FIG. 12 will be described in detail below with reference to Flame, Scene, Page, Flag, and Content variables described in the shooting progress status table (Table 2).

Referring to FIG. 12, in step S1201, the CPU 111 resets the frame counter with a value “0”. In step S1202, the CPU 111 resets the scene counter with a value “0”. In step S1203, the CPU 111 resets a flag array, which indicates whether the image requested to be stored in each frame has been captured, with a value “0”.

In step S1204, the CPU 111 loads the shooting instruction information that has been added to the template. Instep S1205, the CPU 111 determines whether any frame exists, which belongs to one scene and to which the flag has not been set. If a value “1” has been set to all the flags (NO in step S1205), then the processing proceeds to step S1206. In step S1206, the CPU 111 increments the scene counter to advance to a next scene.

On the other hand, if a frame exists, which belongs to one scene and to which the flag has not been set (YES in step S1205), then the processing proceeds to step S1207. In step S1207, the CPU 111 displays, based on the frame counter, the scene to which the frame belongs and the page of the frame, and the content of the object requested to be stored in the frame, on the image display LCD monitor 602. In step S1208, the CPU 111 receives an operation by the photographer for releasing the shutter, which is executed after the photographer has confirmed the content displayed in step S1207. In step S1209, the CPU 111 stores the image of the object on the buffer.

In step S1210, the CPU 111 extracts the feature amount of the object from the image of the object stored instep S1209. In step S1211, the CPU 111 determines whether the feature amount of the object extracted in step S1210 matches (is the same as) the object requested to be stored in the frame displayed in step S1207.

To paraphrase this, in step S1211, the CPU 111 determines whether the feature amount of the current object matches the feature amount of a previously registered object. More specifically, in this case, the CPU 111 determines that the feature amount of the current image and the feature amount of the previously registered object match each other if the degree of similarity between them falls within a specific tolerance range.

If it is determined that the feature amounts match each other (YES in step S1211), then the processing proceeds to step S1212. In step S1212, the CPU 111 displays a message indicating the matching status on the image display LCD monitor 602. On the other hand, if it is determined that the feature amounts do not match each other (NO in step S1211), then the processing proceeds to step S1213. In step S1213, the CPU 111 displays a message indicating the unmatching status on the image display LCD monitor 602.

In step S1214, the CPU 111 increments the flag that stores the progress of the shooting of the images to be stored in the frame. In step S1215, the CPU 111 increments the frame counter to shift to the processing of a next frame.

In step S1216, the CPU 111 determines whether image shooting for all the frames within the template has been completed. If it is determined that image shooting for all the frames within the template has not been completed (NO in step S1216), then the processing returns to step S1205 and continues the processing. On the other hand, if it is determined that image shooting for all the frames within the template has been completed (YES in step S1216), then the processing ends.

In the present exemplary embodiment, in the processing according to the flow chart of FIG. 12, the image shooting and display of information are advanced by using the scene counter as in the first exemplary embodiment described above. However, the present exemplary embodiment is not limited to this. More specifically, it is also useful if the image shooting and the display of information is executed by using the page counter instead of the scene counter. Furthermore, the present exemplary embodiment can be applied when capturing moving images as well as capturing still images. Moreover, the present exemplary embodiment can be applied regardless of whether the photographer and the user is the same person.

As described above, according to the present exemplary embodiment having the above-described configuration, the CPU 101 previously generates an information-added template and the CPU 111 interprets the received information-added template, registers the object, displays the object information during shooting, and recognizes the captured object.

With the above-described configuration, the present exemplary embodiment, which is capable of automatically determining an object to be stored, enables prevention of a mistaken shooting of an object. Furthermore, the present exemplary embodiment having the above-described configuration, which facilitates shooting an image by executing object recognition, enables shooting as desired by the photographer more easily than in a case where the shooting by the photographer is not facilitated.

In the first and the second exemplary embodiments of the present invention described above, the photographer can continue image shooting while confirming the information displayed on the image display LCD monitor 602 according to the information-added template. However, in this case, it is not easy to grasp or recognize a final state of an album including the captured images in its frame included in the template.

Accordingly, a third exemplary embodiment of the present invention displays an outer shape of an actual template on the image display LCD monitor 602. Furthermore, the present exemplary embodiment enables the photographer to execute image shooting while confirming the state of the captured images being stored in each frame.

With this configuration, the photographer can confirm a layout substantially similar to the final format of an album. Accordingly, the present exemplary embodiment is capable of reducing complicated operations for generating an album and setting a layout.

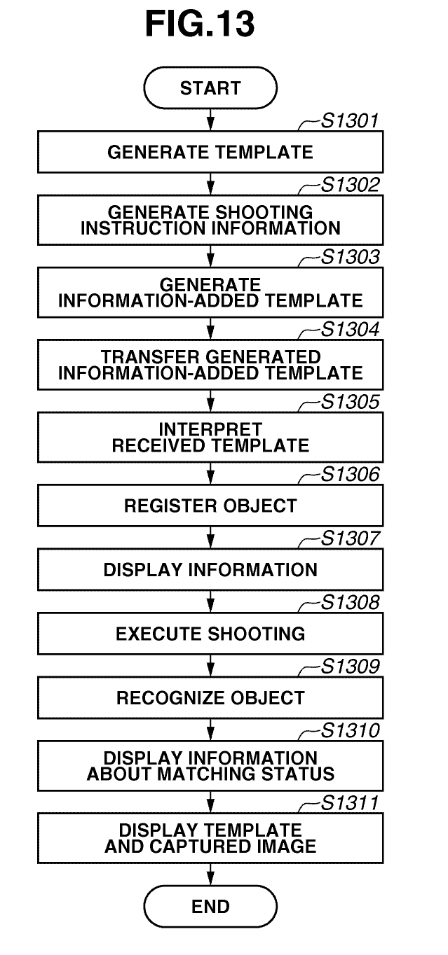

Now, an exemplary flow of processing executed by the information processing apparatus and the imaging apparatus according to the present exemplary embodiment will be described in detail below with reference to a flowchart of FIG. 13. FIG. 13 is a flow chart illustrating an example of processing according to the present exemplary embodiment. Description of apart of hardware configuration of the information processing apparatus and the imaging apparatus according to the present exemplary embodiment similar to that of the first exemplary embodiment described above will not be repeated in the following description.

Referring to FIG. 13, in step S1301, the CPU 101 generates a template similar to the processing in step S201 (FIG. 2). In step S1302, the CPU 101 generates shooting instruction information similar to the processing in step S202 (FIG. 2).

In step S1303, similar to the processing in step S203 (FIG. 2), the CPU 101 combines the template generated in step S1301 with the information instruction table generated in step S1302, and generates an information-added template by adding the shooting instruction information to the template.

In step S1304, the CPU 101, similar to the processing in step S204, stores the information-added template on the memory card via the I/O device 107. In addition, the CPU 101 transfers the information-added template to the imaging apparatus.

In step S1305, the CPU 111 of the imaging apparatus interprets the content of the information-added template transferred thereto in step S1304, similar to the processing in step S205.

In step S1306, similar to the processing in step S1006 (FIG. 10) described above in the second exemplary embodiment, the CPU 111 generates a list of objects having unique feature amount based on the content of the object interpreted in step S1305, and registers each object.

In step S1307, the CPU 111 displays the content of the information-added template interpreted in step S1306 on the image display LCD monitor 602.

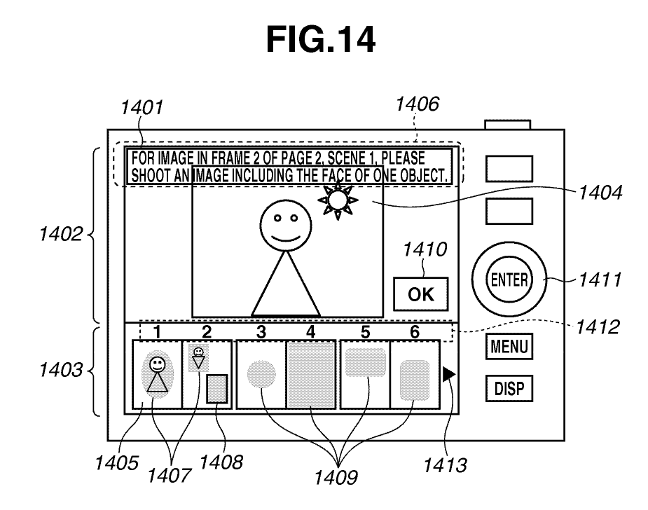

Now, the content to be displayed on the image display LCD monitor 602 will be described in detail below with reference to FIG. 14. FIG. 14 illustrates an example of information displayed on the image display LCD monitor 602 according to the present exemplary embodiment.

Referring to FIG. 14, the image display LCD monitor 602 has an upper divided portion, which is a live view layer 1402, and a lower divided portion, which is a layout preview layer 1403. The outer shape of a template is displayed in the layout preview layer 1403.

In addition, a field 1405 displays an outer shape of the template for a first page. A field 1406, which is illustrated in FIG. 14 with a dotted-line rounded rectangle, displays a message related to the content of the object to be stored in the frame of the scene to be captured and for the corresponding page number.

A frame 1408 is a specific frame included in the template. The frame 1408 is highlighted by surrounding it with a thick-line rectangle, for example. More specifically, in the frame 1408, an image of an object to be captured from now is to be stored after shooting the object image.

To paraphrase this, if a plurality of frames has been output to the output device 115, the CPU 111 highlights the frame, of the plurality of frames, in which the object image captured by the imaging device 116 is to be stored. In other words, the imaging apparatus includes a highlight unit configured, if a plurality of storage areas of the template has been output, to highlight the storage area based on the shooting instruction information, from among the plurality of storage areas, in which the captured object image is to be stored.

A frame 1409 is a frame in which no image has been stored yet. A numerical value indicated in a field 1412 indicates the page number of the template. An interface 1413 is an interface for displaying a template that is not displayed in the layout preview layer 1403 in the current display state by scrolling the same.

The interface 1413 is selected and scrolled by operating the input device 114, such as a dial-like button 1411 or an input button.

More specifically, the photographer can recognize the state of progress of the shooting by confirming the state of images being stored in the frames 1407 and 1409 by operating the input device 114.

In other words, the imaging apparatus includes a status output unit, which is implemented by the CPU 111 for example, configured to output the status of progress of shooting to the output device 115 based on the storage area included in the template and the image of the object stored in the storage area.

It is also useful if next information is displayed while skipping the display of current information. If the display of the current information is skipped, it is useful if the display of the content of the object whose image has been currently requested to be captured and stored is skipped. In addition, it is also useful if a list of shooting instructions is displayed.

As described above, in step S1307, the CPU 111 displays the image captured in step S1304 on the image display LCD monitor 602, in a state in which the image is stored in the template within the layout preview layer 1403 (FIG. 14), which displays the outer shape of the template. In frames 1407, an already captured image, which is included in each frame 1407, is displayed.

More specifically, the CPU 111 outputs information about whether the image of the object captured by the imaging device 116 has been stored in the storage area to the output device 115 based on the storage area included in the template and the image of the object stored in the storage area.

In step S1308, the imaging apparatus captures images that are candidates of images to be stored in the frame. The captured images are stored on the primary storage device 112 and the secondary storage device 113 of the imaging apparatus.

Instep S1309, the CPU 111 executes image recognition on the image captured and stored on the primary storage device 112 or the secondary storage device 113 in step S1308.

More specifically, in step S1309, the CPU 111 extracts a feature amount of the object (the face of the person (object) in the present exemplary embodiment) by analyzing the image data (in a narrower sense, face data) captured in step S1308. Furthermore, the CPU 111 searches for a person having the most approximate feature amount from among the plurality of feature amounts of the faces registered in step S1306.

In step S1310, the CPU 111 determines whether the content of the image captured in step S1309 matches the content of the object described in information displayed in the field 1406. In addition, the CPU 111 displays a result of the determination on the image display LCD monitor 602. In the example illustrated in FIG. 14, shooting of “one face” has been requested and the captured image satisfies the requested condition. Accordingly, the CPU 111 displays a message 1410, which indicates the matching status, on the image display LCD monitor 602.

In the present exemplary embodiment, the CPU 111, in step S1306, registers an object. In addition, the CPU 111 recognizes the object and searches for a unique feature of a person in step S1309. However, the present exemplary embodiment is not limited to this. More specifically, it is also useful if the CPU 111 registers and recognizes an outer appearance of a person taken in an image, which has a unique feature amount other than a face of an object, in addition to or instead of the feature amount of the face.

As described above, the present exemplary embodiment executes the processing in step S1306 for allowing the photographer to execute shooting while the imaging apparatus previously registers a feature unique to an object, recognizes the feature of the object, and displays information unique to the object to the photographer. However, it is also useful if the above-described processing in step S1306 is omitted.

In addition, a configuration, which can change and confirm the method of the display executed in steps S1307 and S1310 described above with reference to FIG. 14, may be employed.

In other words, the configuration of the present exemplary embodiment is not limited to the simultaneous display of the live view layer 1402 and the layout preview layer 1403 on the image display LCD monitor 602. More specifically, it is also useful if either the live view layer 1402 or the layout preview layer 1403 only is displayed. Alternatively, it is also useful if the display of the layers can be switched.

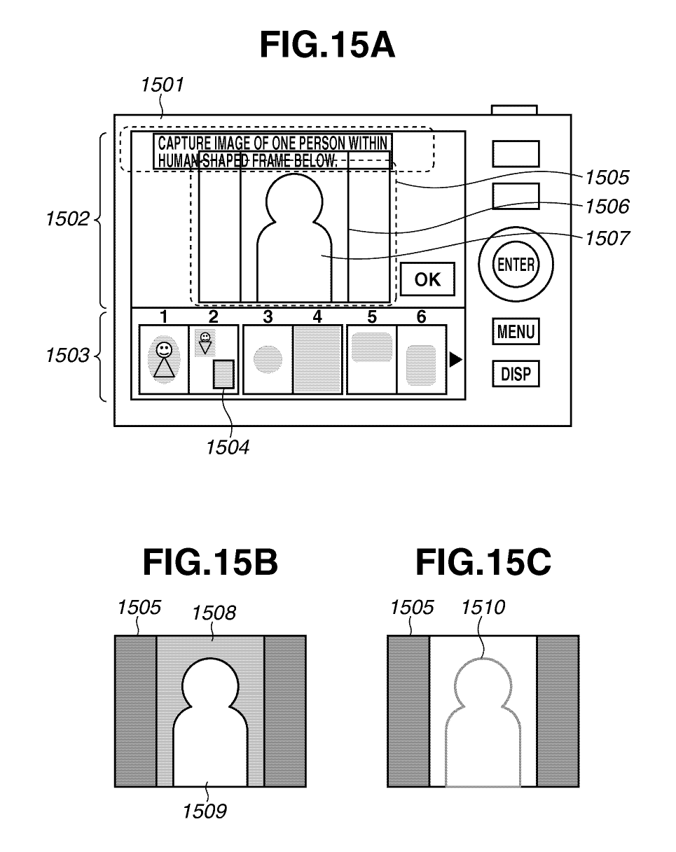

In the present exemplary embodiment, the method for instructing shooting is not limited to the method illustrated in FIG. 15A, in which a message including a text string is displayed in a shooting instruction display field 1501 and an image storage target frame 1504 is displayed in a layout preview layer 1503 according to the outer appearance of an actual template. More specifically, it is also useful if information is displayed that visually instructs a position for shooting an object on a live view layer 1502.

In the example illustrated in FIG. 15A, a dotted-line round rectangle 1505 indicates an image shooting scope set by a viewfinder of the imaging apparatus. Furthermore, a dotted-line rectangle 1506 indicates a trimming area, which corresponds to a frame 1504 that is an image storage target frame for current shooting displayed on the layout preview layer 1503.

A field 1507 indicates the outer appearance of an object whose image is currently requested to be captured and stored. More specifically, in the present exemplary embodiment, it is instructed to capture a person (object) so that the image of the object comes within a frame indicating a person-shape field 1507 by displaying a shooting instruction “Please shoot an image of one person so that the image comes within the person-like shape displayed below.” in a field 1501. For the person-like shape field 1507, it is useful if a person-like shape inside field area 1509 (FIG. 15B) is displayed at a transparency degree of 100%, and the outside field of the person-like shape 1508 is displayed in a non-transparent state. Alternatively, it is also useful if a person-like shape field 1510 only is displayed as illustrated in FIG. 15C.

Therefore, the imaging apparatus includes a preview unit configured, if a storage area included in a template has been output to the output device 115, to display in the unit of the storage area, by preview, information about the outer shape of the object to be stored in the storage area according to the shooting instruction information included in the template. In the present exemplary embodiment, the CPU 111 implements the preview unit, for example.

In addition, it is also useful if it is permitted to shoot a plurality of images as candidates of images to be included in one frame. In this case, it is useful if a list of images that are candidates to be included in one frame is displayed on the image display LCD monitor 602 to allow the user to narrow down and select an image or to set an order to the candidate image.

If it is permitted to shoot a plurality of images as candidates of images to be included in one frame, it is also useful if one folder is provided within the imaging apparatus for one frame and a captured image, which has been previously selected as the candidate, is selectively stored in the folder.

For a method for storing captured images in the template, it is useful if the user selects an image displayed in the live view layer 1402 and drag-and-drops the selected image on a frame included in the template that is the target frame of storing the image. The above-described configuration can be employed if the image display LCD monitor 602 includes a touch sensor.

Suppose that a method for inserting a template via a touch panel is employed. In this case, if it has been permitted to shoot a plurality of images as candidates of images to be stored in one frame, the imaging apparatus displays a list of images that are candidates of images to be stored in one frame on the image display LCD monitor 602.

In this case, it is also useful if the user is allowed to further narrow down the images to select images to be stored in one frame. Furthermore, it is also useful if the user is allowed to set an order to the candidate images. In addition, the present exemplary embodiment can be applied when capturing moving images as well as capturing still images. Moreover, the present exemplary embodiment can be applied regardless of whether the photographer and the user is the same person.

As described above, according to the present exemplary embodiment having the above-described configuration, the CPU 101 previously generates an information-added template and the CPU 111 interprets the received information-added template, registers the object, displays the object information and the outer shape of the template during shooting, and recognizes the captured object.

With the above-described configuration, the present exemplary embodiment is capable of facilitating shooting an image by the photographer. By facilitating shooting an image by the photographer, the present exemplary embodiment having the above-described configuration is capable of suppressing or at least reducing errors occurring when shooting an image of an object. In addition, the present exemplary embodiment having the above-described configuration is capable of allowing the photographer to shoot an image of an object according to the template.

Furthermore, with the above-described configuration, the present exemplary embodiment is capable of allowing the photographer to confirm the layout of a product of the shooting, such as an album, while shooting an object image. Accordingly, the present exemplary embodiment having the above-described configuration is capable of increasing the efficiency in executing a work flow for generating an album, which is less efficient in the conventional method. Therefore, the present exemplary embodiment is capable of preventing the photographer (user) from having to execute complicated operations for setting a layout.

According to each exemplary embodiment of the present invention described above, shooting instruction information is output when executing shooting. Furthermore, each exemplary embodiment of the present invention is capable of appropriately facilitating shooting an image by saving the photographer executing complicated operations for selecting and classifying the captured images after shooting by indicating an image of an object to be captured by using shooting instruction information.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-202963 filed Sep. 2, 2009, which is hereby incorporated by reference herein in its entirety.

What is claimed is:

1. An imaging apparatus comprising:
a reading unit configured to read a template, in which storage area information, which indicates a plurality of storage areas for storing an image of an object captured by an imaging device, is associated with shooting instruction information for instructing shooting of an image to be stored in each of the plurality of storage areas; and
an output unit configured, if an image to be stored in one of the plurality of storage areas is to be captured, to output the shooting instruction information associated with the one storage area in the template read by the reading unit, to an output device.

2. The imaging apparatus according to claim 1, further comprising:
a recognition unit configured to recognize an object included in the image captured by the imaging device;
a first determination unit configured to determines whether the object recognized by the recognition unit is an object matching the shooting instruction information output by the output device; and
a first determination result output unit configured to output a result of the determination by the first determination unit to the output device.

3. The imaging apparatus according to claim 1, further comprising:
an extraction unit configured to extract a feature amount of an object included in the image captured by the imaging device;
a second determination unit configured to compare the feature amount extracted by the extraction unit and a feature amount of an image to be stored in the storage area associated with the shooting instruction information output by the output unit, from among feature amounts of images to be stored in a storage area described in the storage area information included in the template read by the reading unit, which feature amount having been previously registered, and to determine whether a current object is identical with a previously registered object based on a result of the comparison; and
a second determination result output unit configured to output a result of the second determination unit to the output device.

4. The imaging apparatus according to claim 1, further comprising:
a first area output unit configured to output the plurality of storage areas included in the template read by the reading unit to the output device; and
a highlight unit configured to highlight a storage area in which an image of the object captured by the imaging device is to be stored, from among the plurality of storage areas, according to the shooting instruction information included in the template.

5. The imaging apparatus according to claim 1, further comprising:
a second area output unit configured to output a storage area included in the template read by the reading unit to the output device; and
a preview unit configured to display in a unit of the storage area, by preview, information about an outer shape of an object captured in an image to be stored in the storage area according to the shooting instruction information included in the template.

6. The imaging apparatus according to claim 1, further comprising a selection unit configured to allow a user to select one piece of shooting instruction information from among a plurality of pieces of shooting instruction information output by the output device.

7. The imaging apparatus according to claim 1, further comprising an image storage status output unit configured to output information about whether the image of the object captured by the imaging device has been stored in the storage area according to a storage area included in the template read by the reading unit and the image of the object that has been stored in the storage area.

8. The imaging apparatus according to claim 1, further comprising a status output unit configured to output status of progress of shooting to the output device according to the storage area included in the template read by the reading unit and the image of the object that has been stored in the storage area.

9. A method for shooting an image, the method comprising:
reading a template, in which storage area information, which indicates a plurality of storage areas for storing an image of an object captured by an imaging device, is associated with shooting instruction information for instructing shooting of an image to be stored in each of the plurality of storage areas; and
outputting, if an image to be stored in one of the plurality of storage areas is to be captured, the shooting instruction information associated with the one storage area in the read template, to an output device.

10. A non-transitory computer-readable storage medium storing instructions which, when executed by a computer, cause the computer to perform operations comprising:
reading a template, in which storage area information, which indicates a plurality of storage areas for storing an image of an object captured by an imaging device, is associated with shooting instruction information for instructing shooting of an image to be stored in each of the plurality of storage areas; and
outputting, if an image to be stored in one of the plurality of storage areas is to be captured, the shooting instruction information associated with the one storage area in the read template, to an output device.
